(19) United States
(12) Patent Application Publication
(10) Pub. No.: US 2021/0110742 A1
(43) Pub. Date: Apr. 15, 2021

(54) Tangle-Free Flag

(71) Applicant: Stephen E. Moor, Point Pleasant, NJ (US)

(72) Inventor: Stephen E. Moor, Point Pleasant, NJ (US)

(21) Appl. No.: 17/032,987

(22) Filed: Sep. 25, 2020

Related U.S. Application Data
(60) Provisional application No. 62/905,903, filed on Sep. 25, 2019.

(51) Int. Cl. G09F 17/00

(52) U.S. Cl. CPC G09F 17/00; G09F 2017/0008

(57) ABSTRACT

A tangle-free flag or banner that incorporates anti-fall back feature[s] that incorporates a weighted and flexible fly hem that is integrally built into the flag/banner that acts as a stabilizing keel. This design implementation provides much greater self-righting capabilities and prevents tangling and furling by taking advantage of the external forces of gravity in concert with the nature of the lift created by the wind and its attendant forces.

This is a non-provisional utility patent application which is a continuation of U.S. provisional patent application Ser. No. 62/905,903 filed Sep. 25, 2019.

### BACKGROUND OF THE INVENTION

The present invention relates to any and all types of flags and banners. Flags and banners come in all shapes and sizes and have been around for centuries.

It is quite common for ordinary flags/banners to get tangled when flown out of doors in the wind and the elements. It is important to note that flags generally get tangled by falling back on themselves after the lift created by the forces of the wind drops out from underneath the flag. So, the problem that needs to be addressed is twofold: 1.) How to keep a lightweight flag/banner from falling back on itself and dropping onto the flagpole and tangling. 2.) How to keep a flag from getting tangled in the flags rigging and furling.

When a flag becomes rolled-up on itself or becomes twisted around the flagpole this scenario is often referred to as furling. The flag/banner can also get tangled in the halyard's rigging or the related mounting hardware that is incorporated to secure the flag to the flagpole or mount.

Flags/banners have a natural tendency to get caught up in a gust of wind and they will invariably fall back on themselves and then get tangled around the flagpole or they can get hung up on other nearby objects such as gutters, roofs, trees, bushes and the like.

This happens because most flags/banners do not weigh much at all. They are constructed out of lightweight materials; usually a single sheet of cloth, or sheets of cloth sewn together. The most durable flag material used for challenging outdoor conditions are Nylon with a specific gravity of 1.13 and Polyester with a specific gravity of 1.30. However, flag construction is not just limited to these two materials. For example, there are various other material choices such as cotton and cotton-polyester blends as well as other fabric choices and various other combinations.

Another factor is that most flags or banners are uniformly weighted. Specifically, other than the halyard hem which adds just a fraction more weight; [just several grams which would include the grommets and the reinforced hem]; there isn't a single part of a flag or banner that is appreciably heavier than another part. Therefore, the weight of a flag/banner is uniformly distributed throughout.

Flags by design are not specifically weighted with the intention of favoring one part of the flag/banner over another part in order to fly in concert with the fickle nature of the wind. Flags are not purposely designed to take advantage of the available gravitational forces that could potentially be harnessed in their favor in order to keep them from falling back on themselves and furling.

It is especially common for flags and banners to get wrapped around themselves or tangled when flown out of doors. This especially occurs when a flag or banner is hung, mounted or flown on a flagpole attached to a building, a structure or an immovable object such as a tree. Common mounting angles range from perpendicular or 90° degrees and 135° degrees. However, the flags being flown are not limited to just these two commonly used angles. They can be flown at any angle whatsoever.

What commonly occurs is that a flag/banner gets caught up, even in a gentle gust of wind and the lift created by the forces of the wind drops out and the flag or banner falls back onto itself and the flag/banner drops out of the air. The result is that the flag drops onto the flagpole and will eventually get wrapped around the pole or it will get tangled in the rigging.

This happens regardless of whether anti-tangling hardware is employed or not. This happens even though this hardware is designed to allow the flag to spin around the flagpole 360°. The problem is the flag cannot do that because it is too light. The premise of a flag rotating 360° around a flagpole is flawed from the onset. Rarely, if ever, will a flag whether weighted or not, spin 360° around a flagpole.

What actually occurs in the real world is as follows: A flag being flown on a side mounted flagpole can frequently rise above the plane of the pole driven by a gust of wind. As is often the case, the lift that has been keeping the flag aloft, drops out causing the flag to fall back on itself. This routinely happens because the wind primarily consists of gusts or bursts of energy. So, after the gust subsides, the lift that has been holding the flag above the plane of the flagpole dies out as well. The flag immediately begins to lose its buoyancy and begins to fall back on itself, and in so doing, it will frequently drop onto the flagpole and furl.

### BRIEF SUMMARY OF THE INVENTION

Method 1.) The most popular solution put forth in order to deal with this natural limitation inherent in both flag and banner design, has been the implementation of anti-tangle or tangle-free rigging. These anti-tangle fixtures now come as standard equipment on flagpoles that are typically designed to be attached or mounted to a building.

These anti-tangle fixtures are also offered on flagpoles that are designed to be erected from the ground 180° straight up.

These fixtures come already mounted or supplied with the purchase of the flagpole and they are usually made from plastic. These anti-tangle fixtures are also readily available and can be purchased separately. They can be used to replace an old worn out set or applied as an upgrade to an old-style pole. These fixtures are generally made from plastic; however, the better-quality models are constructed out of metal.

Popularly available flagpoles come with (2) anti-tangle fixtures that are intended to prevent the flag from furling or becoming tangled. Most of the popular tangle-free flagpoles employ a 360° swivel collar that is located at the tip of the flagpole. The first collar is attached to either ornamental ball at the top of the flagpole or it is attached to the pole just under it.

The second collar that comes with the flagpole assembly has two built in features. The first component enables the collar to be slid onto the pole and locked down in place. The second feature of the collar is a built-in bushing that provides a point of attachment for the flag. This bushing swivels freely and will allow the flag/banner to rotate 360° around the flagpole. Once the flag has been attached to this adjustable collar and that collar is in position, it can then be locked down with a set screw that has been provided. At that point, the flag will be allowed to swivel on the rotating bushing contained within that collar a full 360°.

After the flag has been attached to the pole via the 2 collars, the flag is free to rotate a full 360° around the flagpole.

These collars swivel and provide excellent mobility for a blowing flag, there is no dispute regarding that capability. However, they do not eliminate a flag/banner from getting tangled when blowing in the wind. The reason why these anti-tangle systems do not work as proposed, are because flags are exceptionally light in weight. For example, a commonly available 3′×5′ flag constructed out of durable all-weather nylon weighs in at a mere 8.8 ounces. Those specifications illustrate just how light of an object a flag is and how easy it is for one to get caught up in a gust of wind.

In the case of side mounted flagpoles, the type[s] that are attached to a building, the flag can routinely fly above the plane of the flagpole. The problem occurs when the lift created by the wind drops out, causing the flag to fall back on itself. When the flag falls back on itself, the flag will drop onto the flagpole and furl. On this particular flagpole set-up [under natural wind conditions], neither present flag design; nor these anti-tangle devices will allow a lightweight flag to spin around the pole 360° and right itself.

Furthermore, present flag design will not allow a lightweight flag to right itself, like a keel-weighted object can. Although these anti-tangle devices intend to prevent this from happening, they cannot, since they are attempting to overcome some immutable principals of gravity which they are incapable of doing under the present design limitations.

Though these anti-tangle devices are designed to allow the flag to twirl or rotate around the flagpole, they are only moderately successful at preventing furling or entanglement. Unfortunately, they do not work as put forth, since they are incapable of overcoming the design limitations that are embodied in lightweight flag design.

Flags in their present form are not designed to self-right themselves or to be tangle free. Due to a flag's lightweight nature, these anti-tangle appliances are not effective in keeping the flag from falling back on itself and furling.

Anti-tangle fixtures alone cannot keep a flag from falling back on itself and furling, especially being flown on side mounted flagpoles. What is lacking in this present condition, is the proper ballast and the corresponding gravitational forces needed to act on that ballast in order to allow these anti-tangle devices to perform as intended.

Method 2.) Another popular solution put forth, is a flag design that has a built-in sleeve in the halyard hem of the flag. Whereby the flagpole gets inserted into the hollow halyard hem and is secured to the flagpole via that method. This design is meant to have the flag twirl around the flagpole via the hollow halyard hem that acts like a hollow mounting tube.

This design fails to adequately prevent furling as well, because the flag utilized in this system is also constructed out of light weight material[s] that will allow the flag to fall back on itself as already put forth in (method 1).

Method 3.) A third solution, and not nearly as commercially popular, is to add stiffeners; weighted or otherwise, to the flags internal or external structure. This is typically done by adding a stiffening material to a flag or a banner in order to keep it from furling or tangling up.

The stiffening material can be applied to a flags field hem[s] or its field. This stiffening material is usually constructed out of a rigid or semi-rigid plastic material. The problem occurs when a stiffening material either weighted or not, is incorporated into the flags design. The addition of stiffeners is purposely done in order to prevent the flag from furling or tangling. Although the addition of stiffeners may prevent the flag/banner from furling or tangling it does not come without adverse effects. The stiffened flag/banner assumes a visibly distinct unnatural stiffness and an unnatural wave when under sail. These added stiffeners deny the flag to assume its natural tendency of freedom and fluid mobility. The addition of stiffeners impedes the flags natural ability to exhibit a natural flow whether hanging at rest or sailing in the wind. The tradeoff is having a flag that takes on the appearance of a stiff sheet. This condition presents an unnatural appearance and the improvement as put forth is not a desirable trade off.

It must be noted, that one of the most important attributes of a flag/banner is its natural ability to fly and dance with total freedom on the currents of the wind. Additionally, a flag/banner must hang limp and exhibit a natural drape under windless conditions. This system as put forth fails to recognize those demands. If this design had proved successful, it would be both popular and available for purchase in the public domain. Reference U.S. Pat. No. 6,845,730 B2 Cardarelli

As put forth, a lightweight flag or banner cannot be adequately controlled by any of the afore proposed methods. So, in order to overcome these limitations, the object of this present invention to is to design a tangle-free flag that will perform in virtually all outside weather conditions. To develop a natural looking and naturally flying flag or banner that will not fall back on itself and will resist furling in both low level and high wind conditions. To design a tangle-free flag/banner that will incorporate anti-fall back feature[s] that will provide much greater self-righting capabilities by taking advantage the wind, the nature of the lift created by the wind and the external forces of gravity.

Description of an Ordinary Flag or Banner

### BRIEF DESCRIPTION OF DRAWINGS

FIG. 1 is an image of an American Flag, where

1 is the field or ground area of the flag.

2 is the canton as featured in the flag of The United States of America.

3, 4, 5 & 5a represent the four hems that border the flag. 3 is also the hoist side or halyard hem of the flag

4 is also the fly end hem of the flag.

5 & 5a represent the top hem and bottom hem of the flag.

FIG. 2 contains a series of images of weighted/ballasted tube types.

FIG. 2a is a segmented weighted tube.

FIG. 2b is a unsegmented weighted tube.

FIG. 2c is a round segmented weighted tube.

FIG. 2d is a flat segmented weighted tube.

FIG. 2e is a round unsegmented weighted tube.

FIG. 2f is a flat unsegmented weighted tube. Typically, there are two larger or heavy hems; one of which is located at the hoist side or halyard 3 and the other at fly end side of the flag 4.

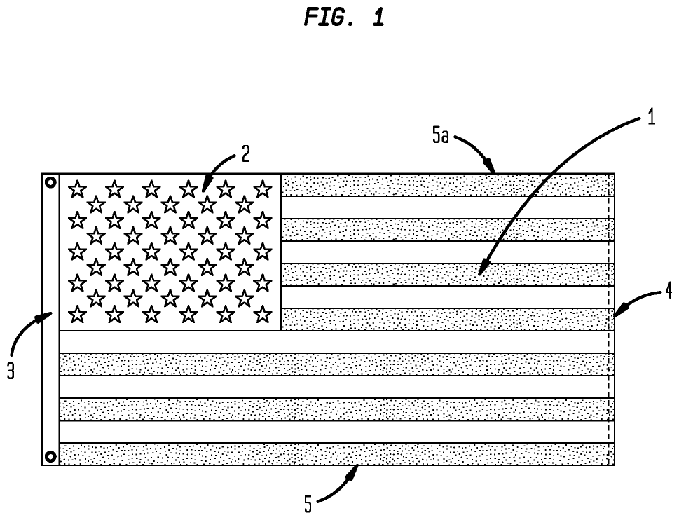

All that is required to qualify as a flag is a field area which is the flag body itself 1. The body is surrounded by 4 hems: 3 & 4 and 5 & 5a. In the case of flags there are always four hems.

The halyard side incorporates a heavy hem 3, because this is the side of the flag that provides the attachment points to the flagpole rigging. In most cases, there are a pair of heavy-duty grommets; one located at the top corner and the other at the bottom corner of the hem. These attachment points allow the flag to be hung or flown. The halyard hem requires significant durability as well as flexibility in order to allow the flag to flow freely and dance upon the wind.

The fly end of the flag has a heavy-duty hem as well 4, since it is the area that is subjected to severe service. The fly end is the part of the flag that is subjected to the most wind resistance as it flies and snaps in the wind. Typically, when a flag becomes worn and frayed, it most often occurs at the fly end of the flag due to all of the violent flapping the flag gets subjected to. Both the top and bottom hems 5 & 5a of a flag or banner are typically thinner and these hems are not nearly as robust as the halyard hem or the fly end hem.

In the case of triangular shaped banners there are only three field hems, with the only heavy hem located on the halyard side of the banner. The other two hems are smaller in size and often meet at the end forming a triangular point.

In the case of patriotic banners, specifically, American in theme, funeral themed or otherwise, the most common design is a semi-circular in nature, having a continuous hem along the curved axis of the banner and a single hem that runs across the top.

### DETAILED DESCRIPTION OF INVENTION

In order test this concept, we will focus on side mounted flagpoles. This improved tangle-free flag is going to incorporate a strategically placed [in the proper amount(s)] flexible ballast into the basic design of the flag/banner. This weighted material or ballast can be incorporated in any of the four hems that surround the flag/banners field area and is intended to keep a flag from falling back on itself.

For the purposes of illustration, prototype development and subsequent flying trials; this improvement will focus on weighting or ballasting, the flag's fly end hem. However, this is by no means intended to limit the placement of this flexible weighted material. Neither its weight, nor its material composition, nor its placement or design is limited by the referencing the augmentation of the flags fly hem. This is meant to allow anyone skilled in the art to visually conceptualize what is being done and the principals that support why it is being done.

It is important to note, that flags/banners can also furl when mounted to a free-standing flagpole that are erected straight up or 180° degrees from its base located on the ground. Although these flagpoles typically have a much more complex and sophisticated rigging system than those described in (method 1), they are not immune from flag entanglement. This particular arrangement typically incorporates a halyard rigging for the hoisting and the lowering of the flag or banner from ground level to the top of the flagpole.

As one can imagine, a badly furled flag atop a flagpole anywhere from 10′ to 50′ feet off the ground can pose quite a problem. Despite best efforts, it is not uncommon for the fly end of the flag to get tangled up in the halyard rigging and wrap the flagpole. This can happen due to the flag whipping around and blowing back on itself, even when it is being flown on a 180° pole. This scenario is exacerbated when the flag's fly end hem is frayed.

The improved tangle-free flag with its strategically placed ballast incorporated into the design of the flag/banner[s] fly end hem would greatly reduce this from occurring even on flagpoles erected at 180°. In either case, a flag/banner flown on either a side mounted pole [flown at any desired angle] or a free-standing pole generally erected at 180° [but not necessary limited to 180°, there could be multiple variations] would benefit from a flexibly ballasted fly end hem in order to keep the flag from tangling due to falling back on itself. These improvements will be built into the flag itself; specifically, in any of the four the hem[s] or in any combination thereof. This improvement will enhance the performance of, and work in concert with, any and all of the popular anti-tangle appliances and halyard rigging found on the market.

Of paramount importance is that when the flag is being flown, it flows naturally and dances upon the wind, especially under high wind conditions. It is also designed to move and dance equally well under both low wind and breezy conditions. The natural movement of the flag is not to be impeded or it will defeat the purpose of this improvement. The flag when it is at rest in windless conditions must hang naturally and exhibit a natural drape. Any improvement to this improved tangle-free flag must strive to remain visually pleasing when under sail or at rest and it must strive as much as possible to resemble a flag/banner that has not been altered.

It has been well observed that majority of the flags presently being flown incorporate external tangle-free flagpole fixtures. It has been well observed that these fixtures do not eliminate flag furling as claimed and it is in part this deficiency that this invention seeks to correct.

Flags/banners are naturally prone to falling back on themselves during flight. This commonly occurs when the lift created by the wind drops out. As noted, flags are light weight and uniformly weighted throughout. By design, flags/banners were never designed to prevent themselves from falling back and to self-right. It is this apparent deficiency that this invention in part, seeks to correct. It is these two major flaw[s] that are embodied in this flag and flagpole system that this improved tangle-free flag in part, seeks to overcome.

Thus far, reinforcing the fly hem doesn't seem to indicate that it is necessary in order for this improvement to be successful 4. However, this deficiency needs to be represented as a proposed improvement to the improved tangle-free flag/banner (4). As mentioned, the fly end hem is subjected to a great deal of friction, especially if it is consistently being flown in a high wind environment. It is well known to those skilled in the art, that the fly end hem is the part of the flag that is most susceptible to becoming frayed and coming apart. It must be noted that when the fly end frays, especially on a traditional 180° flagpole, it is quite common for the frayed fly end to become entangled in the halyard rigging.

This improved tangle-free flag will incorporate the addition of weighted material or ballast into the flags design; more specifically, the hem[s]. The weighted materials/ballast being employed must be abundant, readily available, and must be extremely low-cost in order to make this improvement cost effective and a desirable option for the commercial flag manufactures.

When deciding upon a suitable material for the prototype's ballast, the material selected was quartz-based sand. Though many other materials were considered, none of them fit the parameters as set forth, and from a cost standpoint, all of them were prohibitively more expensive.

Sifted beach sand is primarily made up of fine grains of quartz having a specific gravity of 2.66. The type of quartz-based sand selected for this trial was devoid of any appreciable amounts of organic material. It must be noted, that when this particular material is mined/quarried from the source, this material is typically pure sand and absent of any organic material.

From a material standpoint, a quartz-based sand or white sand can be easily sourced and would add negligible cost to the overall price of the finished product. An approximate cost of this material is $40 per ton, which breaks down to approximately 02 per pound. In this particular trial, 5.5 ounces of sand was used in the flexible tube that was incorporated into the fly end hem of a standard 3′×5′ flag. At this rate, 5,800 flags could be weighted for under a 0% cent per flag.

It is imperative that the ballast be non-degrading and non-weathering in nature and must have an acceptable specific gravity in order to perform the task at hand. Additionally, quartz-based sand demonstrates a natural tendency to flow and move upon itself, providing a ballast that is flexible, a key element in this improvement. It must be stated that the amount of ballast, the specific weight of the ballast employed, nor its material makeup is in no way limited to parameters outlined in this particular prototype trial. Other ballast materials could/may be utilized, but they would have to be selected based upon the same criteria.

This quartz sand ballast material right out of the ground has a small enough grain size without requiring any additional processing steps. Other than perhaps washing, it could readily be poured in, pumped-in or encapsulated in a tube-like structure.

However, if it is desirable that this sand have a smaller screen size in order to obtain a greater mass per tube volume[mm³], it could be crushed in order to obtain a smaller grain size to further reduce the existing space between grains, but as it appears, this would not be necessary. This would be done at the prerogative of the manufacturer and could easily be achieved by using a ball mill.

In the case of a tube-like structure the tube would first be filled, then cut to length for the particular flag being made and then sewn shut. If segments are desired, pleats can be added either during or after their construction. The finished tube would then be placed into the fold[s] of the flag's hem[s] and become an integral part of the flags internal structure.

These tubes can be designed to be either segmented or unsegmented. It is an important design parameter that these sand filled tubes remain as flexible as possible. The tubes designed with multiple pleats or segments would exhibit far greater flexibility and fluidity. The tubes would then be incorporated into a flag or banners basic design in order to prevent the flag/banner from furling or tangling due to the flag falling back on itself. These tubes would then be incorporated in the flags internal hem structure and remain virtually hidden.

By adding a small amount of weight/ballast in the right places and by the right means will keep a flag flying in all types of wind conditions and keep it from falling back on itself. The key is to add weight in the form of ballast to an existing product that typically has little weight to begin with. As noted, the specific gravity of the fabric used in the manufacture of all-weather flags ranges from 1.13 for Nylon and 1.30 for Polyester. The specific weight of the quartz sand ballast is 2.66, which is over 2 times greater than the material that what an all-weather flag is typically made of.

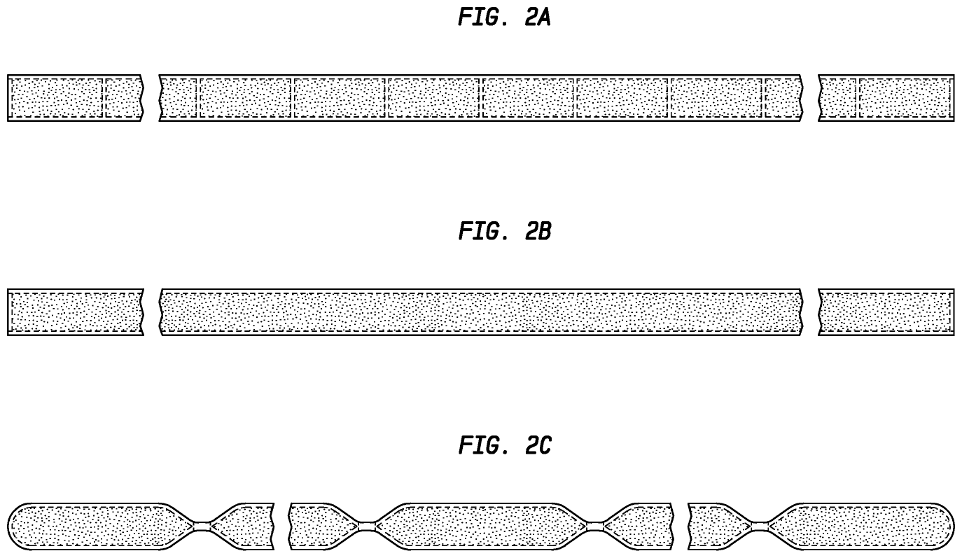

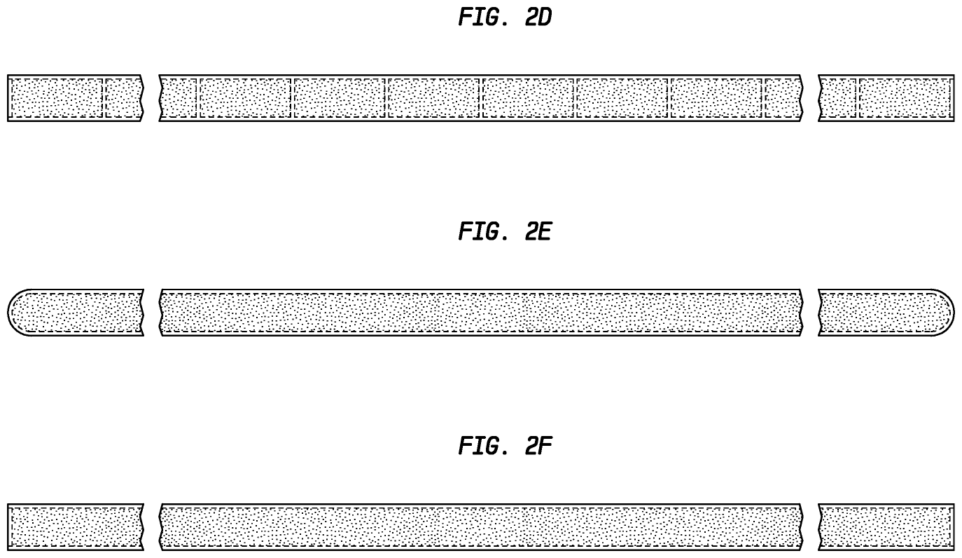

FIG. 2 These weighted tubes can be segmented FIG. 2a or unsegmented FIG. 2b.

These tubes would be incorporated in any of the four hems of a flag/banner, whether singularly, or in any combination thereof. The key to achieving this is that these tubes must exhibit both the proper weight, dimensions and flexibility in order to maintain the natural flow and freedom inherent in the flags natural design to fly. These weighted tubes must be flexible enough in order to allow the flag to assume its natural flexibility whether at it be at rest or under full sail.

These tubes can be rounded or flattened in shape. They can be segmented FIG. 2a or unsegmented FIG. 2b. The description for the round segmented shape would be akin to a chain of very thin breakfast sausages comprised of multiple links FIG. 2c.

The description for the flattened segmented design would be akin to placing pillow-like square raviolis' next to each other forming a chain FIG. 2d. The description for the unsegmented round design would be one thin continuous round; like one long breakfast sausage FIG. 2e.

The description for the flattened unsegmented tube would be that of a long continuous strip of ravioli FIG. 2f. It is imperative that the addition of these tubes must not interfere with the flag's general outward appearance, flowability and natural ability to sail on the wind.

These tubes can be constructed out of a weather-proof type of lightweight nylon or polyester material [the same material used in the flag's body] or some other suitable woven material. These tubes would be filled with a weighted material, something as ordinary as washed fine-grained quartz-based sand. The tubes if divided into segmented sections; can be divided into various lengths depending upon placement: whether in the fly end hem, the halyard hem or the upper or lower field hems.

These weighted tubes, segmented or otherwise, are sewn into the flags hem[s] upon initial construction at the point of manufacture. These sand filled tubes would be pre-manufactured, precut to order [depending on the flag's dimensions] and are an efficient way of incorporating this improvement in a cost-effective manner at the point of the manufacture when the flag's hems are being sewn shut.

It is important to note that the afore mentioned examples are by no means meant to limit the mechanisms or means for this flag's proposed ballast system. Neither the ballast material or its composition; the tube style or its design; nor its manufacture or its implementation are in any way limited to the possible methods that have been put forth. This illustration has been based upon limited trials and is meant to inform anyone skilled in the art of the many possibilities that may yet apply.

### Initial Test Details and Location

The test came about because I was forever untangling my furled flag. The flag being flown was an Annin 3′×5′ all-weather nylon flag. The flag was attached to a 5′ wooden flagpole equipped with fully functioning plastic anti-tangle devices. The angle of the side-mounted flagpole was customarily set at the 135° angle and the pole was inserted and locked down in the mounting bracket made of pot metal. The bracket offers 2 standard positions: 90° and 135°.

This setup was attached to a residential ranch style home and the home is exposed to the prevailing winds for this locale. The front of the home faces North and the home is sits in an East/West orientation. The home is located 1 mile from the Atlantic Ocean where the most common wind direction is Easterly, split between winds emanating out of both the Northeast and Southeast directions.

During storm conditions the prevailing winds generally emanate from the North East direction. After these low-pressure systems pass off the Atlantic coast, the area routinely experiences heavy West winds that blow off the land toward the ocean. The flagpole, though unintentionally, was ideally setup to intercept these prevailing winds and was a perfect candidate for flying trials.

### Test One

On Aug. 25, 2019 the test site was experiencing intermittent 20 knot North Easterly winds, perfect for observing if this early prototype would work. The flag undergoing the test was a well broken in Annin 3′×5′ nylon all-weather flag with brass grommets. It must be noted that this flag would constantly furl on this pole.

In order to create a repeatable performance baseline, the exact same flag, now modified with the ballasted fly end hem and was tested on this flagpole.

The flag that underwent this test was the exact same flag, the Annin 3′×5′ all-weather nylon flag. For this trial, the fly end hem was opened and a segmented sausage-like tube that contained 5.5 ounces of ballast was sewn into the hem. The segments of this tube were approximately 4″ in length and this tube ran the entire length of the fly ends hem. The ballast was ordinary beach sand comprised primarily of very small grains of quartz. The sand was not so fine as to be powdery as if it had been run through a ball mill.

It is important to note that this trial was intentionally being conducted without the advantage using any anti-tangle fixtures. Both of the anti-tangle fixtures had been removed from the flagpole before the start of the trial.

This test was purposely conducted without the aid of any outside appliances or fixtures designed to aid the flag from tangling. The ballasted flag being tested had been directly attached to the flagpole employing only single loops for attachment through each grommet, using thin diameter nylon cordage. The top loop was pulled tightly and attached to the pole just beneath the decorative ball. The bottom loop was then pulled tightly around the pole and then tied off at the base of the flagpoles mount attached to the house.

The flag being tested was intentionally mounted so that it could not spin or twirl. Every effort was put forth for the flag to fall back on itself and tangle. As a matter of course, the most tangle prone flagpole arrangement and tangle prone means of attachment were specifically chosen in order to prove that the concept would work without the aid or assistance of any tangle-free appliances or rigging. This was intentionally done in order to determine whether further testing would be merited or whether the concept should be abandoned altogether.

During this test, the flagpole was intermittently set at both the 135° angle and at the 90° angle in order to observe both commonly flown angles. The flag during this trial never fell back on itself or furled. Based upon these results, it was decided to undergo a second test.

### Test Two

In preparation for this test, an identical Annin 3′×5′ all-weather nylon flag was purchased at Walmart. Just like the first test, the fly end hem of this brand-new flag was opened up and the previously made ballast tube was inserted into the open hem, then the hem was stitched back in place.

This time, the improved tangle-free flag was tested on a modern 5′ one-piece aluminum flagpole manufactured by Besty Flags, also purchased at Walmart. The flagpole being utilized was and equipped with a set of plastic anti-tangle devices to which the flag was attached.

This flags performance was observed on Sep. 6, 2019 during the passing of Hurricane Dorian off the NJ coast. As previously stated, the test location was approximately 1 mile directly inland from the Atlantic Ocean. The event provided many hours of all types of winds and heavy gusts, many exceeding well over 20 knots. The winds were predominately out of the East North East for many hours and then after the low pressure had passed, the winds came hard out of the West.

The prototype during this significant blow performed flawlessly on a 5′ foot aluminum flagpole equipped with plastic anti-tangle collars.

This prototype continues to be under observation and is still exceeding all expectations. After 20 days of observation, this flag has not furled once, and this location has since experienced a lot of variable and gusty wind conditions. Prior, to this test, this flag furled multiple times per day.

Unlike the prior art, and the other commonly offered products that seem to have overpromised about their anti-tangling abilities, adequate prototype testing is essential when it comes to proof of concept, especially when it comes to improving upon an existing technology and developing a commercially viable product that may supersede what is presently being consumed.

### Observations

This improved tangle-free flag was designed to eliminate or significantly reduce the frequency of falling back on itself both with/and without the aid of tangle-free flagpole appliances. However, it has been observed to have superior performance when used in conjunction with these commonly available tangle-free anti-tangle appliances.

Thus far, the flying trials have shown that a weighted and segmented fly end hem alone, allows the flag to sail naturally in the wind and resists falling back on itself. In the event that the improved tangle-free flag does flip over on itself, [which thus far has not been observed], it would be far more able to right itself, because a weighted fly hem is similar in design to that of a weighted keel. This design was intended to take advantage of strategically placed ballast and gravitational forces on that ballast. This ballasted material is intended to affect the flags performance; analogous as to how the weighted keel of a sailboat allows the vessel to sail on turbulent seas in unruly winds. In prototype testing, the fly end's hem had a round weighted and segmented cloth tube sewed into the fold of the hem similar to that of FIG. 2c. The ballast was comprised of ordinary sifted beach sand, and the weighted tube was divided into 4-inch segments with the total weight of the segmented tube being approximately 5.5 ounces.

For those skilled in the art, it cannot be assumed that the number of tube segments, their lengths, weights or dimensions are intended to be limited as to the criteria shared regarding this prototype trial. It also must be stated that the more segments in the ballast tube the more flexible the ballast tube will be. It must be emphatically stated that the ballast tube[s] that may be employed are not limited as to their shape[s], length[s], weight[s], size[s], number of segment[s], ballast material [s], and so forth. The finished ballast tube[s] can have an infinite number of combinations in order to deter the flag/banner from falling back on itself.

In flying trials in heavy winds of 20 knots plus and in other high lift conditions, the prototype has been observed to fly considerably above the plain of the flagpole. This is the zone where it is most prevalent for a standard flag/banner to fall back on itself and furl. During these trials, it had been observed that when the prototype was in this zone and the corresponding lift dropped out, the flag would fold back just forward of the canton's hem and right itself. The proof of concept is that the flag was able to right itself and continue on flying regardless of whether the intermittent gales either added or decreased the lift. This can only be attributed to positive aspect that the ballasted fly end hem has on the flag's ability to fly with complete freedom and not fall back on itself. Trials so far, have been limited to the fly end being ballasted. So far, these trials have demonstrated that this flag design can fly in variable wind conditions of 10 to 20 knots plus for periods extending well over 24 hours in length without any tangling or furling. The phenomenon of the flag falling back, or flag blowing back appears to have been overcome by adding a weighted/segmented cloth tube filled with 5.5 ounces of sifted beach sand for ballast.

It has been observed that the optimum weight for the fly end alone could prove out to be somewhere in the 5-ounce range for a flag whose dimensions are 34.5 wide by 58 inches long, better known as a 3′×5′ flag. The segment size was approximately 4 inches in length and the outside diameter of the tube was under 5/16^{ths} of an inch for the crudely made ballast tube. The tube diameter could be significantly reduced if it were professionally constructed, or if the sand were crushed in order to reduce the screen size of the sand particles. The segmented tube that was sewn into the fly end hem of the flag ran the length of the hem, except that it was stepped back approximately ½″ from the lighter two field hems 5 & 5a.

For the purposes of illustrating for those skilled in the art, the final tube structure could resemble that of a string of very thin breakfast sausage links before being sewn into the fly end hem. Once the open hem was folded over and the segmented ballast was sewn in, the weighted hem was barely noticeable.

It has been observed that while at rest the flag will hang perfectly limp and exhibits a natural drape as if it had not been altered at all.

Under full sail in 20 knots of wind, the flag waves and snaps just like an unweighted flag except it resists falling back on itself and tangling. It was anticipated that there could be some degree of furling during these conditions, since overcoming a flags propensity to fall back on itself is quite difficult to achieve, but that scenario never occurred.

As observed thus far, 5.5 ounces of segmented sand filled tubing sewn into the hem of the fly end hem negates this from occurring. It is important to note at this time that ballast weight is either exactly where it needs to be, or it could possibly be reduced by an ounce or so. The criteria for making such a determination was based upon 2 separate trials where the improved tangle-free flag was subjected to wind speeds in excess of 20 knots of variable blowing gales, and observing the flag refusing to fall back on itself after the lift would drop out from underneath it.

At this juncture no other weighted segmented tubing has been required to achieve the no-foldback effect, but other variations are under consideration.

It is important to note, that these preliminary tests are in no way limited to any of the components instituted during this trial. Neither the location of the test; notwithstanding the wind direction[s], the size of the flag or the make, the size of the flagpole, design or the make; anti-tangle fixtures or the make, the flagpole mount or the make employed in this test are to be taken as the definitive elements in order to obtain this positive outcome. The results of these limited trial[s] are being shared for those who may be skilled in the art, in order to present a real-world example of how successful this improved tangle-free flag promises to operate in the future.

It is fully understood that this improved tangle-flag will be subjected to an infinite variety of circumstances, weather related and otherwise, all of which present day flags are subjected to on a daily basis.

### Future Manufacturing Options

Depending upon the manufacturer and methods employed, the weighted material could be poured in, pumped in or inserted into the finished hem[s] as a finished tube at any point during fabrication when it is convenient to do so.

If the ballast were to be pumped or poured into a finished hem, pleats could be stitched into the corresponding hem[s] as per the manufacturer's dictates depending what performance characteristics are chosen.

If finished tubes are to be utilized, they would be pre-filled to a specified weight and length and they could be either segmented/unsegmented FIGS. 2 2a & 2b. For the flattened tube design, or the pillow shaped tube design (FIG. 2d), the segments of theses tubes would be constructed by sewing in hems or pleats at the desired segment length. For the rounded tubes like FIG. 2c, the segments could be constructed by tying-off one segment from another or sowing in a tiny hem. These tubes could also be formed by crimping. These crimps could be either plastic or metal crimps or could be constructed by any other method that would produce the rounded shape on either end of the segment.

In any case, these tubes will be placed into the fold of the hem[s] and sewn in. These tubes could also be pulled into the finished hem[s] and then the two ends of the hems sewn shut.

If desired non-segmented tubes (FIGS. 2e & 2f) can be utilized and the pleats or segments can be sewn into the tubes at that time the hem is being constructed making it more of an integral part of the flags structure.

As previously stated, white quartz-based sand is an ideal material for this application. It is plentiful, inexpensive, comes out of the ground free of organic matter and has a wonderfully small particle size or grain structure.

Also as previously stated, there are an infinite number of combinations and manufacturing methods that can be employed regarding the ballast's weight, the choice of hem, the placement ballast in what particular hem[s]; whether segmented or unsegmented. Once determined, as to what hem[s] are to be ballasted, the flag manufacturer based upon experience and best practices will determine if the ballasted hem[s] needs to be reinforced or doubled.

### SUMMARY

It could be concluded that the improved tangle-free flag in combination with the standard antitangle plastic rigging compliments each other's ability to eliminate furling. The weighted tangle free flag makes the anti-tangle rigging work as initially promoted, because now there is finally some external ballast for the gravitational forces to work with. The flag also hangs perfectly limp at rest in no-wind conditions. It flies beautifully from a light breeze to a gale above 20 knots. It is important to note that this improved tangle-free flag works in every spectrum that an ordinary outdoor flag is exposed to, with one major exception; it resists furling. The subtly weighted tangle free flag works as stated.

1. A flag weight comprising a fly hem, where the fly hem is weighted and flexible.

2. The flag weight of claim 1, where the fly hem is integrally built into the flag.

3. A flag, comprising a flag or banner and a flag weight, where the weight is an internal ballasting system comprised of a ballasted fly hem.

4. The flag of claim 3, where the fly hem is weighted with a predetermined amount of ballast that acts like a keel to stabilize the flag from furling.

5. The flag of claim 3, where the fly hem further incorporates a flexible ballast.

6. The flag of claim 3, where the ballasted field hem is adjustable.

7. The flag of claim 3, where the flag weight is comprised of a flexible ballast and a field hem.

8. The flag of claim 3, where the weighted tube is segmented.

9. The flag of claim 3, where the weighted tube is unsegmented.

10. The flag of claim 3, where the weighted tube is selected from the group of round segmented, flat segmented, round unsegmented, and flat unsegmented.

11. The flag of claim 8, where the tube is adjustable.

12. The flag of claim 9, where the tube is adjustable.

13. The flag of claim 1, where the flag weight is quartz-based sand.

14. The flag of claim 1, where the flag weight is granular material.

15. A flag comprising a fly, the flag, and a weighted fly hem.

16. A flag comprised of a flag and a weighted fly hem or halyard hem, where the hem is adequately filled with a predetermined amount of ballast during the manufacturing process.
